(19) United States
(12) Patent Application Publication
(10) Pub. No.: US 2010/0039943 A1
(43) Pub. Date: Feb. 18, 2010

(54) FRAME LOSS MEASUREMENT APPARATUS AND METHOD FOR MULTICAST SERVICE TRAFFIC

(75) Inventors: Jeong-Dong Ryoo, Daejeon-city (KR); Kyung-Mook Lim, Chungcheongbuk-do (KR); Tae-sik Cheung, Daejeon-city (KR); Yoo-Kyoung Lee, Daejeon-city (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Instit, Daejeon-city (KR)

(21) Appl. No.: 12/447,075

(22) PCT Filed: Dec. 6, 2006
(86) PCT No.: PCT/KR2006/005250

§ 371 Date: Apr. 24, 2009

(30) Foreign Application Priority Data
Oct. 24, 2006 (KR) 10-2006-0103692

(51) Int. Cl. H04J 3/14; G06F 11/00

(52) U.S. Cl. 370/242; 714/704; 714/E11.001

(57) ABSTRACT

An apparatus and method for measuring frame loss in multicast service traffic are provided. The method of measuring frame loss includes: counting the number of data frames of a predetermined multicast service flowing into an object network of frame loss measurement; counting the number of data frames of the predetermined multicast service flowing out of the network; and measuring frame loss by comparing the counted number of incoming frames and the counted number of outgoing frames. According to the method and apparatus, in a multicast service environment which is dynamically changing, frame loss of a predetermined multicast service can be conveniently and easily measured.

### TECHNICAL FIELD

The present invention relates to a frame loss measurement apparatus and method, and more particularly, to an apparatus and method for measuring frame loss of a predetermined multicast service when operation, administration and maintenance (OAM) functions required for a metro Ethernet service or carrier Ethernet service are performed in a multipoint connection environment.

### BACKGROUND ART

A metro Ethernet service or carrier Ethernet service is a service which, when there are a plurality of geographically dispersed private communication networks of a user, supports a service provider so that the service provider can connect the plurality of private communication networks by using public communication networks, thereby creating the impression of a single local area network (LAN).

These Ethernet service technologies aim at guaranteeing quality of service (QoS) and high level reliability, and in order to standardize technologies for this aim, international standardization bodies such as the Institute of Electrical and Electronics Engineers (IEEE), MEF, and the ITU Telecommunication Standardization Sector (ITU-T), are carrying out standardization related to the Ethernet OAM.

One of the major functions of the Ethernet OAM is measurement of performance, and in particular, measurement of frame loss is an important function. At a point through which frames are flowing into a network, the number of frames flowing into the network is counted, and at a point through which frames are flowing out, the number of frames flowing out of the network is counted, and then, by comparing the two counted values, the degree of frame loss is calculated.

Though there are standardized methods of measuring frame loss in an end-to-end connection, it is difficult to accurately measure frame loss for a multipoint connection. In the case of unicast in which traffic flows in through one point, travels through an internal network, and then flows out through one of many points, an input end does not know with the destination address information of an Ethernet frame, through which output end the traffic flows out.

Exceptionally, when a fixed path for each point is provided as a full mesh form by using a circuit switch type technology, and if an Ethernet frame flows into a network, a fixed path connected to the destination of the Ethernet frame is determined at the input end. However, the fixed path technology in the form of a full mesh form is used in a limited range, and when multicast traffic should be transferred, it still cannot be known through which output end traffic will flow out. In addition, when an Ethernet frame arrives at an output end, it is difficult to determine according to conventional Ethernet service technology, through which input end the frame has flowed in.

In the case of multicast traffic, the traffic flows into a network through one or a small number of points, is copied inside the network, and flows out of the network through multiple points. Through which ports the frames of the multicast traffic are output after being copied at a switch in the network is determined by a multicast traffic control protocol such as an Internet group management protocol (IGMP). Since switches participating in a predetermined multicast service and the ports of the switches are determined by a multicast control protocol, an incoming end through which traffic flows in should know which switches and/or ports are participating in a predetermined multicast service, in order to measure frame loss.

However, the participating in and seceding from a multicast service is very dynamic, and informing an incoming end of each change in participation in the multicast service is very expensive. Accordingly, in a multipoint connection environment, instead of accurate measurement of frame loss based on counting of data frames, the number of OAM frames which are generated and discarded on the border of a network is counted, and used as an approximate value of the frame loss measurement value of the network. However, this method provides only a rough frame loss of the whole network.

One of the important functions provided by a multipoint connection environment is facilitating implementation of a multicast service. With the introduction of multimedia services such as Internet protocol television (IPTV) and voice on demand (VOD), accurate measurement of frame loss in a predetermined multicast service has become increasingly important. For example, frame loss affects the picture quality of video, and a network provider or operator should necessarily be able to accurately measure frame loss in order to maintain a high level of a service level agreement for a predetermined premium multicast service.

### DETAILED DESCRIPTION OF THE INVENTION

### DESCRIPTION OF THE DRAWINGS

FIG. 1 is a diagram illustrating a network in which a method of measuring frame loss is implemented according to an embodiment of the present invention;

FIG. 2 is a block diagram illustrating an apparatus for measuring frame loss according to an embodiment of the present invention;

FIG. 3 is a block diagram illustrating an apparatus for measuring frame loss according to another embodiment of the present invention;

FIG. 4 is a block diagram illustrating a structure for counting the number of outgoing frames in an apparatus for measuring frame loss according to an embodiment of the present invention;

FIG. 5 is a diagram illustrating a frame used for a method of measuring frame loss as a loss measurement request or response frame according to an embodiment of the present invention;

FIG. 6 is a flowchart illustrating a method of measuring frame loss in a network, according to an embodiment of the present invention;

FIG. 7 is a flowchart illustrating a method of measuring frame loss at an end point of a network through which frames are flowing in, according to an embodiment of the present invention; and

FIG. 8 is a flowchart illustrating a method of measuring the number of outgoing frames in order to measure frame loss in a network, according to an embodiment of the present invention.

### TECHNICAL PROBLEM

The present invention provides an apparatus and method capable of accurately measuring frame loss without prior information on changes in a traffic path of a multicast service or information on from which node traffic is output.

### Technical Solution

According to an aspect of the present invention, there is provided an apparatus for measuring frame loss, including: an incoming frame counting unit counting the number of data frames of a predetermined multicast service flowing into an object network of frame loss measurement; an outgoing frame counting unit counting the number of data frames of the predetermined multicast service flowing out of the network; and a loss measurement unit measuring frame loss, by comparing the number of the data frames counted by the outgoing frame counting unit and the number of the data frames counted by the incoming frame counting unit.

According to an aspect of the present invention, there is provided a method of measuring frame loss, including: counting the number of data frames of a predetermined multicast service flowing into an object network of frame loss measurement; counting the number of data frames of the predetermined multicast service flowing out of the network; and measuring frame loss, by comparing the number of data frames flowing into the network and the number of data frames flowing out of the network.

According to an aspect of the present invention, there is provided an apparatus for measuring frame loss, including: an incoming frame counting unit counting the number of data frames of a predetermined multicast service flowing into an object network of frame loss measurement; a frame transmission and reception unit receiving a loss measurement response frame comprising the number of data frames of the predetermined multicast service which are flowing out of the network; and a loss measurement unit measuring frame loss of the predetermined multicast service based on the number of data frames flowing into the network and the number of data frames flowing out of the network.

According to an aspect of the present invention, there is provided a method of measuring frame loss, including: counting the number of data frames of a predetermined multicast service flowing into an object network of frame loss measurement; receiving a loss measurement response frame comprising an the number of data frames of the predetermined multicast service which are flowing out of the network; and measuring frame loss of the predetermined multicast service based on the number of data frames flowing into the network and the number of data frames flowing out of the network.

According to an aspect of the present invention, there is provided an apparatus for measuring frame loss, including: a request frame reception unit receiving a loss measurement request frame of a predetermined multicast service from an object network of frame loss measurement; an outgoing frame counting unit counting the number of data frames of the predetermined multicast service which are flowing out of the network; and a response frame transmission unit generating a loss response frame comprising the number of data frames flowing out of the network, and transmitting the loss response frame to the destination address of the loss measurement request frame.

According to an aspect of the present invention, there is provided a method of measuring frame loss, including: receiving a loss measurement request frame of a predetermined multicast service from an object network of frame loss measurement; counting the number of data frames of the predetermined multicast service which are flowing out of the network; and generating a loss response frame comprising the number of data frames flowing out of the network, and transmitting the loss response frame to the destination address of the loss measurement request frame.

### Advantageous Effects

According to the present invention, in a multicast service environment of an Ethernet network, frame loss of a predetermined multicast service can be accurately and conveniently measured. In particular, the frame loss can be measured without prior information on a dynamically changing multicast traffic path, and information on which end points are participating in the multicast service.

### Best Mode

According to an aspect of the present invention, there is provided an apparatus for measuring frame loss, including: an incoming frame counting unit counting the number of data frames of a predetermined multicast service flowing into an object network of frame loss measurement; an outgoing frame counting unit counting the number of data frames of the predetermined multicast service flowing out of the network; and a loss measurement unit measuring frame loss, by comparing the number of the data frames counted by the outgoing frame counting unit and the number of the data frames counted by the incoming frame counting unit.

According to an aspect of the present invention, there is provided a method of measuring frame loss, including: counting the number of data frames of a predetermined multicast service flowing into an object network of frame loss measurement; counting the number of data frames of the predetermined multicast service flowing out of the network; and measuring frame loss, by comparing the number of data frames flowing into the network and the number of data frames flowing out of the network.

According to an aspect of the present invention, there is provided an apparatus for measuring frame loss, including: an incoming frame counting unit counting the number of data frames of a predetermined multicast service flowing into an object network of frame loss measurement; a frame transmission and reception unit receiving a loss measurement response frame comprising the number of data frames of the predetermined multicast service which are flowing out of the network; and a loss measurement unit measuring frame loss of the predetermined multicast service based on the number of data frames flowing into the network and the number of data frames flowing out of the network.

According to an aspect of the present invention, there is provided a method of measuring frame loss, including: counting the number of data frames of a predetermined multicast service flowing into an object network of frame loss measurement; receiving a loss measurement response frame comprising an the number of data frames of the predetermined multicast service which are flowing out of the network; and measuring frame loss of the predetermined multicast service based on the number of data frames flowing into the network and the number of data frames flowing out of the network.

According to an aspect of the present invention, there is provided an apparatus for measuring frame loss, including: a request frame reception unit receiving a loss measurement request frame of a predetermined multicast service from an object network of frame loss measurement; an outgoing frame counting unit counting the number of data frames of the predetermined multicast service which are flowing out of the network; and a response frame transmission unit generating a loss response frame comprising the number of data frames flowing out of the network, and transmitting the loss response frame to the destination address of the loss measurement request frame.

According to an aspect of the present invention, there is provided a method of measuring frame loss, including: receiving a loss measurement request frame of a predetermined multicast service from an object network of frame loss measurement; counting the number of data frames of the predetermined multicast service which are flowing out of the network; and generating a loss response frame comprising the number of data frames flowing out of the network, and transmitting the loss response frame to the destination address of the loss measurement request frame.

### Mode of the Invention

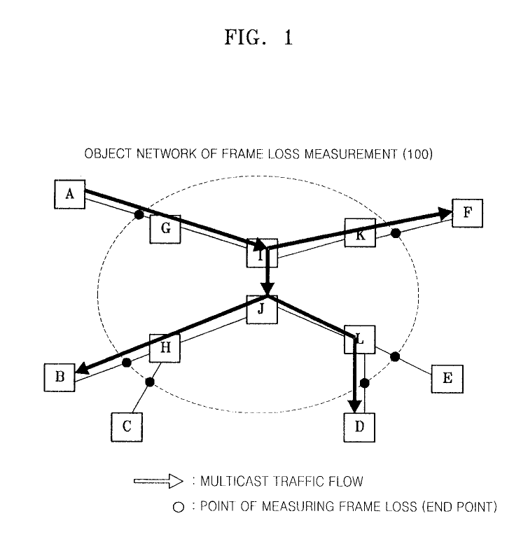

FIG. 1 is a diagram illustrating a network in which a method of measuring frame loss is implemented according to an embodiment of the present invention.

Referring to FIG. 1, the traffic of a predetermined multicast service flows into an object network of frame loss measurement (hereinafter will be referred to as a “network”) 100 through node A and flows out through nodes B, D, and F. The predetermined multicast service traffic which is the object of frame loss measurement arrives at service users directly from the network 100 or through another network.

As time passes by, a new user joins in the multicast service or secedes from (stops receiving) the multicast service, thereby changing nodes through which the predetermined multicast service traffic which has flowed in the network 100 flows out of the network 100.

For example, it is assumed that predetermined multicast service traffic which has flowed in through a current node A is transferred through nodes B, D, and F. Then, after a predetermined time elapses, if no multicast user connected to the node B exists, and a new service user receives the multicast traffic through the node E, the predetermined multicast service traffic is transferred to the nodes D, E, and F.

Thus, participating in and seceding from reception of a predetermined multicast service is performed according to free intentions of services users, and in this case, participating in and seceding from a predetermined multicast service is automatically performed through a multicast control protocol (for example, an Internet group management protocol (IGMP)). Also inside the network 100, traffic is copied in nodes which are determined by the multicast control protocol, and distributed, and the number of nodes participating in the transferring of the traffic changes whenever necessary.

According to the present invention, measurement of loss of predetermined multicast frames transferred through this kind of network is performed at the boundary of the network. For example, referring to FIG. 1, frame loss is measured at boundary points of the network 100 including a point (A,G) where the node A is connected to the node C, and also include points (B,H), (C,H), (D,L), (E,L), and (F,K). Hereinafter these points will be referred to as end points.

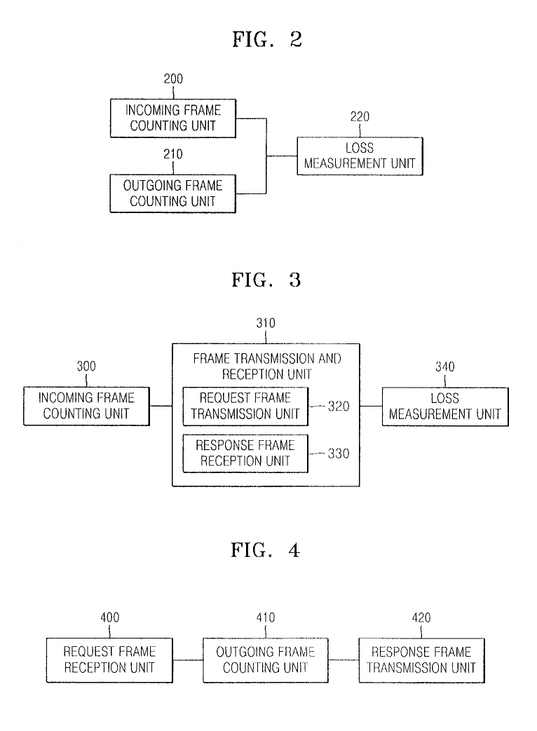

FIG. 2 is a block diagram illustrating an apparatus for measuring frame loss according to an embodiment of the present invention.

Referring to FIG. 2, the apparatus for measuring frame loss according to the current embodiment includes an incoming frame counting unit 200, an outgoing frame counting unit 210, and a loss measurement unit 220.

The incoming frame counting unit 200 counts the number of frames of a predetermined multicast service which flow into an object network of frame loss measurement. For example, in the case illustrated in FIG. 1, if frames of a predetermined multicast service are flowing into the network 100 through the node A, the number of frames which are flowing into the node G from the node A is counted at the end point (A,G).

The outgoing frame counting unit 210 counts the number of frames of the predetermined multicast service which flow out of the network. For example, in the case illustrated in FIG. 1, if frames of the predetermined multicast service are flowing out of the network 100 through the nodes B, D, and F, the number of frames which are flowing out of the network 100 is counted at each of the end points (B,H), (D,L), and (F,K).

The loss measurement unit 220 measures the frame loss based on the number of the incoming frames of the predetermined multicast service counted by the incoming frame counting unit 200 and the number of the outgoing frames of the predetermined multicast service counted by the outgoing frame counting unit 210.

FIG. 3 is a block diagram illustrating an apparatus for measuring frame loss according to another embodiment of the present invention.

Referring to FIG. 3, the apparatus for measuring frame loss according to the current embodiment of the present invention includes an incoming frame counting unit 300, a frame transmission and reception unit 310, and a loss measurement unit 340. The frame transmission and reception unit 310 further includes a request frame transmission unit 320 and a response frame reception unit 330. In the apparatus for measuring frame loss according to the current embodiment, measurement is performed at the boundary of a network. For example, in the case illustrated in FIG. 1, measurement is performed at the end points, including the end point between the node A and the node G.

The incoming frame counting unit 300 counts the number of frames of a predetermined multicast service which are flowing into an object network of frame loss measurement in a predetermined time period.

Immediately after the number of incoming frames is counted by the incoming frame counting unit 300, the frame transmission and reception unit 310 generates a loss measurement request frame, including the number of incoming frames, and then, multicasts the loss measurement request frame. Then, as responses to the loss measurement request frame, the frame transmission and reception unit 310 receives loss measurement response frames, including information on the number of frames of the predetermined multicast service which are flowing out of the network through each of the other end points.

More specifically, the request frame generation unit 320 generates the loss measurement request frame, including a multicast service ID, and information on the number of the incoming frames, and then, multicasts the loss measurement request frame to the inside of the network. The multicast loss measurement request frame is transferred to all other end points in the network.

Then, each of the end points confirms based on the multicast service ID included in the loss measurement request frame, whether or not the end point is participating in the multicast service. Then, if the end point is participating in the multicast service, the end point sends back a loss measurement response frame, including the number of frames of the predetermined multicast service which are flowing out of the network. The response frame reception unit 330 receives the loss measurement response frames transmitted by the end points.

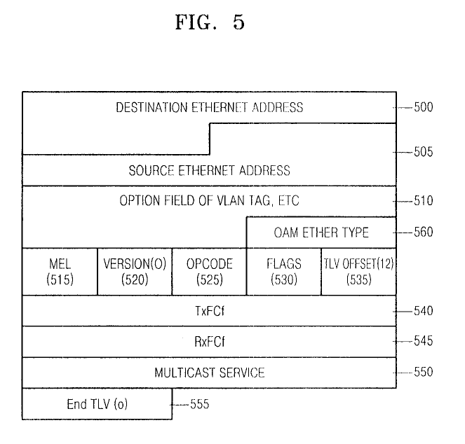

The loss measurement request frame and the loss measurement response frame can be implemented and used in a variety of structures, and one embodiment is illustrated in FIG. 5.

Referring back to FIG. 3, the loss measurement unit 340 measures the frame loss of the predetermined multicast service, based on the number of the incoming frames of the predetermined multicast service counted by the incoming frame counting unit 300, and the number of the outgoing frames of the predetermined multicast service recognized by the frame transmission and reception unit 310. For example, the loss measurement unit 340 can learn the frame loss from the difference between the number of the outgoing frames and the number of the incoming frames.

When the number of incoming frames and the number of outgoing frames are measured in each of a plurality of predetermined time periods, the loss measurement unit 340 can obtain a frame loss according to Equation 1 below:

Frame loss=|the number of incoming frames (t_{c})−the number of incoming frames (tₚ)|−|the number of outgoing frames (t_{c})−the number of outgoing frames (tₚ)| Equation (1)

Here, t indicates a time, and t_{c}>tₚ.

FIG. 4 is a block diagram illustrating a structure for counting the number of outgoing frames in an apparatus for measuring frame loss according to an embodiment of the present invention.

Referring to FIG. 4, the apparatus for measuring frame loss according to the current embodiment of the present invention includes a request frame reception unit 400, an outgoing frame counting unit 410, and a response frame transmission unit 420.

If a loss measurement request frame, including a multicast service ID, is received, the request frame reception unit 400 confirms whether or not the apparatus is participating in a predetermined multicast service corresponding to the multicast service ID. If the apparatus is not participating in the predetermined multicast service, the request frame reception unit 400 discards the received loss measurement request frame.

If the request frame reception unit 400 is participating in the predetermined multicast service, the outgoing frame counting unit 410 identifies the number of outgoing frames of the predetermined multicast service which have flowed out of the network.

The response transmission unit 420 generates a loss measurement response frame, including the number of the outgoing frames, and transmits the loss measurement response frame to the source address of the loss measurement request frame.

FIG. 5 is a diagram illustrating a frame used for a method of measuring frame loss as a loss measurement request or response frame, according to an embodiment of the present invention.

Referring to FIG. 5, the loss measurement request frame and loss measurement response frame are based on an identical Ethernet OAM frame defined in the ITU-T. The OAM frame structure illustrated in FIG. 5 is just one embodiment of the present invention, and the positions and sizes of the fields can be changed in a variety of ways and used according to embodiments, and other types of format of other standardization organizations can also be used. Referring to FIG. 5, the loss measurement request or response frame according to the current embodiment of the present invention includes a destination Ethernet address field 500, a source Ethernet address field 505, a multicast service ID field 550, and a TxFCf field 540.

First, the loss measurement request frame will be explained.

The destination Ethernet address field 500 is a 6-byte field, and includes an address value which designates all end points of an object network of frame loss measurement as destinations. This address value is not the multicast address of the network, and is a value defined as a Multicast Class 1 in an Ethernet OAM related standard of the ITU-T.

The source Ethernet address field 505 is a 6-byte field, and indicates the Ethernet address of an end point through which frames of the multicast service which is the object of the measurement flow.

The multicast service ID field 550 indicates the multicast service which is the object of the measurement. For example, in the multicast service ID field 550, the IP address value of the multicast group which is the object of the measurement may be recorded.

In the TxFCf field 540, the number of incoming frames is recorded.

Also, there are fields that do not directly relate to the present invention, including a VLAN Tag and other option field 51 0, an OAM EtherType field 560, an MEL field 515, a version field 520, an OpCode field 515, a Flags field 530, and a TLV Offset field 535.

The VLAN tag and other option field 510 varies with respect to technologies forming a network, and may be omitted or formed by many fields. The size of the VLAN tag and other option field 510 is variable. If a technology forming a network is based on IEEE 802.1Q, VLAN Tag information is recorded in the VLAN tag and other option field 510.

The OAM EtherType field 560 is a 2-byte field, and includes a value indicating that information after the OAM EtherType field 560 is an Ethernet OAM PDU. The MEL field 515 includes a 3-bit maintenance entity group level value, and indicates the level of an OAM object area. The version field 520 is a 1-byte field in which the version value of an OAM message is recorded. The size of each of the OpCode field 525 and the Flags field 530 is 1 byte. The values recorded in the OpCode field 525 and the Flags field 530 indicate whether the current frame is a loss measurement request frame for measuring frame loss of a multicast service.

The TLV Offset field 535 is a 1-byte field used to indicate the start position of a TLV field. In the case illustrated in FIG. 5, there is no separate TLV field, and therefore the TLV Offset field 535 has a value of 12. The End TLV field 55 is a 1-byte field always having a value of 0, and indicates that a TLV field ends.

Next, the loss measurement response frame will be explained.

The destination Ethernet address field 500 is a 6-byte frame, and the value of the source Ethernet address field of the loss measurement request frame is copied and recorded in the destination Ethernet address field 500.

The source Ethernet address field 505 is a 6-byte field, and contains the Ethernet address of an end point which generates and transmits the loss measurement response frame.

The multicast service ID field 550 indicates the multicast service which is the object of the measurement, and is the same as the value expressed in the loss measurement request frame. When the IP address value of a multicast group is used as the multicast service ID, the size of the IP address is 4 bytes long.

The TxFCf field 540 is a 4-byte field, and the value of the TxFCF field of the loss measurement request frame is copied and recorded in the TxFCf field 540.

An RxFCf field 545 is a 4-byte field, and when the loss measurement request frame is received, the number of frames which have flowed out of the current network is recorded in the RxFCf field 545.

Other fields are the same as described above in relation to the loss measurement request frame.

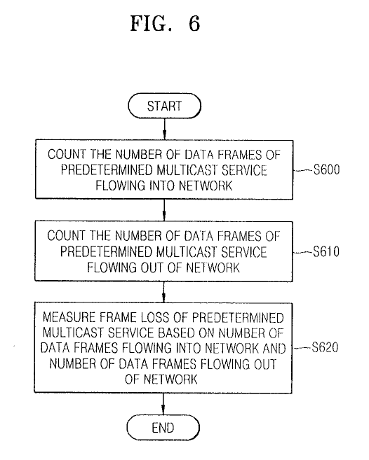

FIG. 6 is a flowchart illustrating a method of measuring frame loss in a network, according to an embodiment of the present invention.

Referring to FIG. 6, the number of data frames of a predetermined multicast service which are following into an object network of frame loss measurement is counted in operation S600. Then, the number of data frames of the predetermined multicast service which are flowing out of the network is counted in operation S610. The frame loss of the predetermined multicast service is measured based on the two counting results, i.e., the number of the incoming frames and the number of the outgoing frames, in operation S620.

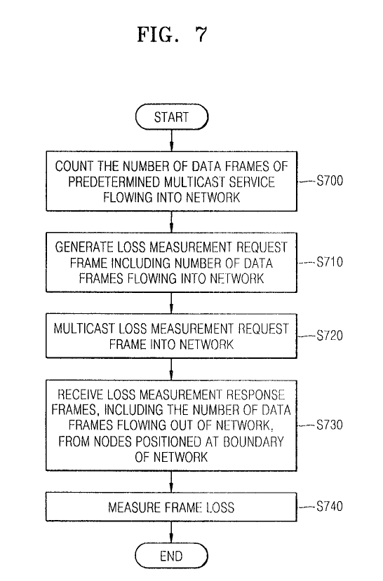

FIG. 7 is a flowchart illustrating a method of measuring frame loss at an end point of a network through which frames are flowing in, according to an embodiment of the present invention.

Referring to FIG. 7, an end point positioned at the boundary of a network through which data frames of a predetermined multicast service are flowing into the network, the number of data frames which are flowing into the network in operation S700. The end point generates a loss measurement request frame including a multicast service ID and the number of the incoming frames in operation S710, and multicasts the frame to the inside of the network in operation S720.

If the multicast loss measurement request frame is received, each of all other end points positioned at other locations of the boundary of the network, determines based on the multicast service ID, whether or not the end point is participating in the multicast service. If it is determined that the end point is participating in the multicast service, the end point generates a loss measurement response frame, including information on the number of the outgoing frames which have flowed out of the network, and sends the frame back to the end point which transmitted the loss measurement request frame, in operation S730.

The end point which receives the loss measurement response frame measures the frame loss of the predetermined multicast service, based on the difference between the number of the incoming frames and the number of the outgoing frames in operation S740.

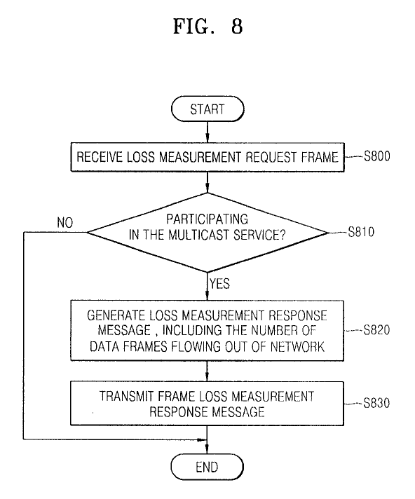

FIG. 8 is a flowchart illustrating a method of measuring the number of outgoing frames in order to measure frame loss in a network, according to an embodiment of the present invention.

Referring to FIG. 8, an end point positioned at the boundary of a network through which frames are flowing out of the network receives a loss measurement request frame from an end point positioned at the boundary of the network through which frames are flowing into the network, in operation S800.

The end point which receives the loss measurement request frame confirms, based on a multicast service ID included in the loss measurement request frame, whether or not the end point is participating in the multicast service, in operation S810.

If it is determined that the end point is participating in the multicast service, the end point generates a loss measurement response frame, including the number of the outgoing data frames of the predetermined multicast service corresponding to the multicast service ID which have flowed out of the network, in operation S820. Then, the end point transmits the generated loss measurement response frame to the end point which transmitted the loss measurement request frame, in operation S830.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. An apparatus for measuring frame loss, comprising:
an incoming frame counting unit counting the number of data frames of a predetermined multicast service flowing into an object network of frame loss measurement;
an outgoing frame counting unit counting the number of data frames of the predetermined multicast service flowing out of the network; and
a loss measurement unit measuring frame loss, by comparing the number of the data frames counted by the outgoing frame counting unit and the number of the data frames counted by the incoming frame counting unit.

2. A method of measuring frame loss, comprising:
counting the number of data frames of a predetermined multicast service flowing into an object network of frame loss measurement;
counting the number of data frames of the predetermined multicast service flowing out of the network; and
measuring frame loss, by comparing the number of data frames flowing into the network and the number of data frames flowing out of the network.

3. An apparatus for measuring frame loss, comprising:
an incoming frame counting unit counting the number of data frames of a predetermined multicast service flowing into an object network of frame loss measurement;
a frame transmission and reception unit receiving a loss measurement response frame comprising the number of data frames of the predetermined multicast service which are flowing out of the network; and
a loss measurement unit measuring frame loss of the predetermined multicast service based on the number of data frames flowing into the network and the number of data frames flowing out of the network.

4. The apparatus of claim 3, wherein the frame transmission and reception unit comprises:
a request frame transmission unit generating and transmitting a loss measurement request frame, comprising a source address and a multicast service ID indicating the predetermined multicast service, setting all nodes positioned at the boundary of the network as destination addresses; and
a response frame reception unit receiving the loss measurement response frame, comprising the number of data frames of the multicast service which are flowing out of the network, from each of a plurality of nodes participating in the predetermined multicast service from among the nodes receiving the loss measurement request frame.

5. The apparatus of claim 4, wherein the request frame transmission unit generates the loss measurement request frame which further comprises the number of data frames flowing into the network, and
the response frame reception unit receives the loss measurement response frame comprising the number of data frames flowing into the network and the number of data frames flowing out of the network, and
the loss measurement unit measures the frame loss based on the difference between the number of data frames flowing into the network and the number of data frames flowing out of the network included in the loss measurement response frame.

6. The apparatus of claim 3, wherein each of the loss measurement request frame and the loss measurement response frame is an operation, administration and maintenance (OAM) frame.

7. The apparatus of claim 3, wherein the frame transmission and reception unit transmits the loss measurement request frame and receives the loss response frame in each of a plurality of predetermined time periods, and
the loss measurement unit measures the frame loss based on the number of data frames which are flowing into the network during the predetermined time interval and the number of data frames which are flowing out of the network during the predetermined time period.

8. A method of measuring frame loss, comprising:
counting the number of data frames of a predetermined multicast service flowing into an object network of frame loss measurement;
receiving a loss measurement response frame comprising an the number of data frames of the predetermined multicast service which are flowing out of the network; and
measuring frame loss of the predetermined multicast service based on the number of data frames flowing into the network and the number of data frames flowing out of the network.

9. The method of claim 8, wherein the receiving of the loss measurement response frame comprises:
generating and transmitting a loss measurement request frame, comprising a source address and a multicast service ID indicating the predetermined multicast service, setting all nodes positioned at the boundary of the network as destination addresses; and
receiving the loss measurement response frame, comprising the number of data frames of the multicast service which are flowing out of the network, from each of a plurality of nodes participating in the predetermined multicast service from among the nodes receiving the loss measurement request frame.

10. The method of claim 8, wherein the receiving of the loss measurement response frame comprises transmitting the loss measurement request frame and receiving the loss response frame in each of a plurality of predetermined time periods, and
the measuring of the frame loss comprises measuring the frame loss based on the number of data frames which are flowing into the network during the predetermined time period and the number of data frames which are flowing out of the network during the predetermined time period.

11. An apparatus for measuring frame loss, comprising:
a request frame reception unit receiving a loss measurement request frame of a predetermined multicast service from an object network of frame loss measurement;
an outgoing frame counting unit counting the number of data frames of the predetermined multicast service which are flowing out of the network; and
a response frame transmission unit generating a loss response frame comprising the number of data frames flowing out of the network, and transmitting the loss response frame to the destination address of the loss measurement request frame.

12. The apparatus of claim 11, wherein the outgoing frame counting unit transmits the loss response frame if it is determined, based on a multicast ID included in the loss measurement request frame and indicating the predetermined multicast service, that the outgoing frame counting unit is participating in the multicast service.

13. The apparatus of claim 11, wherein the request frame reception unit receives the loss measurement request frame, comprising the number of data frames of the predetermined multicast service which are flowing into the network, and
the response frame transmission unit transmits the loss measurement response frame, comprising the number of data frames flowing into the network and the number of data frames flowing out of the network.

14. A method of measuring frame loss, comprising:
receiving a loss measurement request frame of a predetermined multicast service from an object network of frame loss measurement;
counting the number of data frames of the predetermined multicast service which are flowing out of the network; and
generating a loss response frame comprising the number of data frames flowing out of the network, and transmitting the loss response frame to the destination address of the loss measurement request frame.

15. The method of claim 14, wherein in the counting of the number of data frames flowing out of the network, if it is determined based on a multicast ID included in the loss measurement request frame and indicating the predetermined multicast service, that the multicast service is participated in, the loss response frame is transmitted.

16. The method of claim 14, wherein the loss measurement request frame comprises the number of data frames of the predetermined multicast service which are flowing into the network, and the loss measurement response frame comprises the number of data frames flowing into the network and the number of data frames flowing out of the network.
